(19) United States
(12) Patent Application Publication
(10) Pub. No.: US 2006/0254108 A1
(43) Pub. Date: Nov. 16, 2006

(54) Electrical discharge immobilization weapon projectile having multiple deployed contacts

(76) Inventor: Yong S. Park, La Canada, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 11/110,201

(22) Filed: Apr. 20, 2005

(51) Int. Cl. F41C 9/00; H01T 23/00

(52) U.S. Cl. 42/1.08; 89/1.11; 361/232

(57) ABSTRACT

A unitary projectile for an immobilization weapon and tethered by two electrical wires, has a plurality of electrical contacts including several contacts dispersed in a spaced pattern around the projectile after target impact. The pattern of several contacts substantially increases the probability that if the projectile hits the target, an immobilization circuit through the target will be completed. The deployment of the second contacts occurs as a result of the sudden deceleration of the projectile when it impacts the target or by the use of an additional spring-biased device. This simplifies the deployment as well as the projectile configuration and likely reduces the risk of misactivation or an ill-timed activation of the second contacts. In a preferred version of the disclosed embodiments, each projectile has its own electrical contact which forms one of the two polarities of the electrical discharge. In addition, there are preferably four second polarity contacts dispersed in a symmetrical arrangement around the projectile.

### BACKGROUND OF THE INVENTION

1. Field of the Invention

This invention relates generally to the field of non-lethal weapons for immobilizing a live target for capture and more specifically to such a weapon having a wire-tethered projectile configured for long distance usage by employing wires carrying positive and negative polarities from a high voltage source and contacts for applying the voltage across the target, the distance between the contacts on the target being substantially constant irrespective of distance to the target.

2. Prior Art

This invention is intended as an improvement over the invention disclosed in previously issued U.S. Pat. No. 5,831,199 to McNulty, Jr. et al. That prior art patent discloses an immobilization weapon which employs a projectile launched toward a remote target and having two connectors for applying a high voltage discharge across spaced locations on the target. A key innovation of that invention is the use of a first connector on the projectile and a second connector contained within the projectile. The second connector is deployed after the projectile impacts the target by using a propulsion device for actuating separation of the second connector from the projectile at a selected angle so that the second connector impacts the target at a fixed spacing relative to the first connector impact location.

The discussion of the existing prior art in the '199 patent disclosure is quite thorough and comprehensive and is therefore hereby incorporated herein by reference as if fully set forth herein.

A principal advantage of the '199 invention is derived from the fixed spacing between the first and second connectors. More specifically, because the spacing is determined by the design and configuration of the projectile and the second connector's orientation prior to deployment, the spacing does not change regardless of the distance traveled by the projectile before reaching the target. This contrasts with more conventional Taser™ projectiles which use two propulsion deployed connector darts which separate by a distance proportional to their travel distance to a remote target. Thus, these connector darts may be too close together at close targets and too far apart at distant targets. Therefore, these conventional Taser™ devices are severely limited in their range of effectiveness which the '199 patent disclosure reported as 3 to 12 feet.

There are two distinct limitations to the '199 invention. One such limitation is the use of only one second connector. Even though the '199 constitutes a significant advance of the then existing prior art, having just one second connector incurs the risk of an ineffective shot because the second connector may still fail to attach to the target or may entirely miss the target if the first connector is close to the edge of the target and the orientation of the projectile causes the second connector to travel beyond that edge. Another such limitation is the use of a secondary propulsion device to deploy the second connector. If the secondary propulsion device fails to activate or activates too early or too late, the operation and effectiveness of the weapon will likely fail.

It would be highly advantageous to exploit the innovative concept disclosed in the '199 patent, but in a manner which overcomes such limitations.

### SUMMARY OF THE INVENITON

The present invention provides improved implementation of the immobilization weapon concept that employs a single projectile with multiple contacts. Various alternative embodiments are disclosed herein. Such embodiments overcome the aforementioned limitations by utilizing several second contacts deployed in a pattern around the projectile and by obviating the use of a secondary propulsion device. The pattern of several second contacts substantially increases the probability that if the projectile hits the target, an immobilization circuit through the target will be completed. The deployment of the second contacts occurs as a result of the sudden deceleration of the projectile when it impacts the target or by the use of a spring-biased device. This simplifies the deployment as well as the projectile configuration and likely reduces the risk of misactivation or an ill-timed activation of the second contacts.

In a preferred version of the disclosed embodiments, each projectile has its own electrical contact which forms one of the two polarities of the electrical discharge. In addition, there are preferably four second contacts dispersed in a preferably symmetrical arrangement around the projectile. In a first embodiment, these second contacts are formed as elongated arms which are folded aerodynamically behind the projectile during flight and which open about respective fulcrums to form an array of spider-like legs after impact. Pointed barbs are used to promote attachment to the target.

In the another embodiment, the second contacts are formed in four distinct wire-tethered barbed fleshettes in respective angular recesses in the projectile body. The unrestrained fleshettes are released from their respective recesses upon projectile impact.

In such embodiments, spring loading may be used to assist deployment of the second contacts. Furthermore, a simple battery-operated circuit in the projectile may be used to select the pair of contacts which provides the highest effective immobilization current through the target after impact.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional view of a first embodiment of the invention in its flight mode;

FIG. 2 is a side view of the first embodiment of FIG. 1;

FIG. 3 is a three-dimensional view of the first embodiment in its target deployed mode;

FIG. 4 is a side view of the first embodiment of FIG. 3;

FIG. 5 is a three-dimensional view of a second embodiment of the invention in its flight mode;

FIG. 6 is a side view of the second embodiment of FIG. 5;

FIG. 7 is a side view of the second embodiment in its target deployed mode;

FIG. 8 is a three-dimensional view of the second embodiment in its target deployed mode;

FIG. 9 is a three-dimensional view of a third embodiment of the invention in its flight mode;

FIG. 10 is a side view of the third embodiment of FIG. 9;

FIG. 11 is a three-dimensional view of a fourth embodiment of the invention in its flight mode;

FIG. 12 is a side view of the fourth embodiment of FIG. 11;

FIG. 13 is a three-dimensional view of the fourth embodiment in its target deployed mode; and

FIG. 14 is a schematic block diagram of an illustrative contact selection circuit.

### DETAILED DESCRIPTION OF PREFERRED EMBODIMENTS

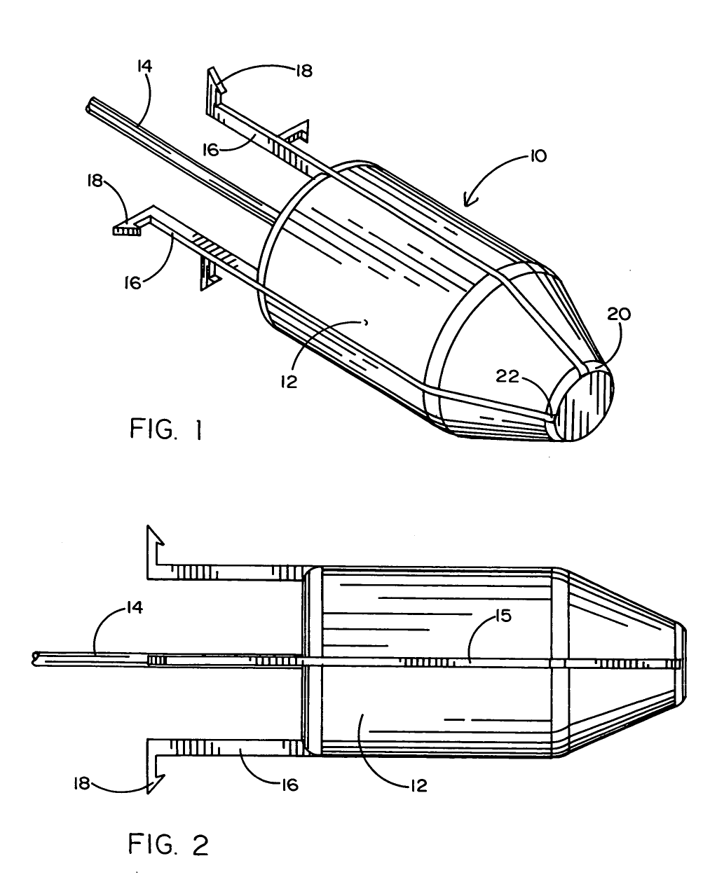

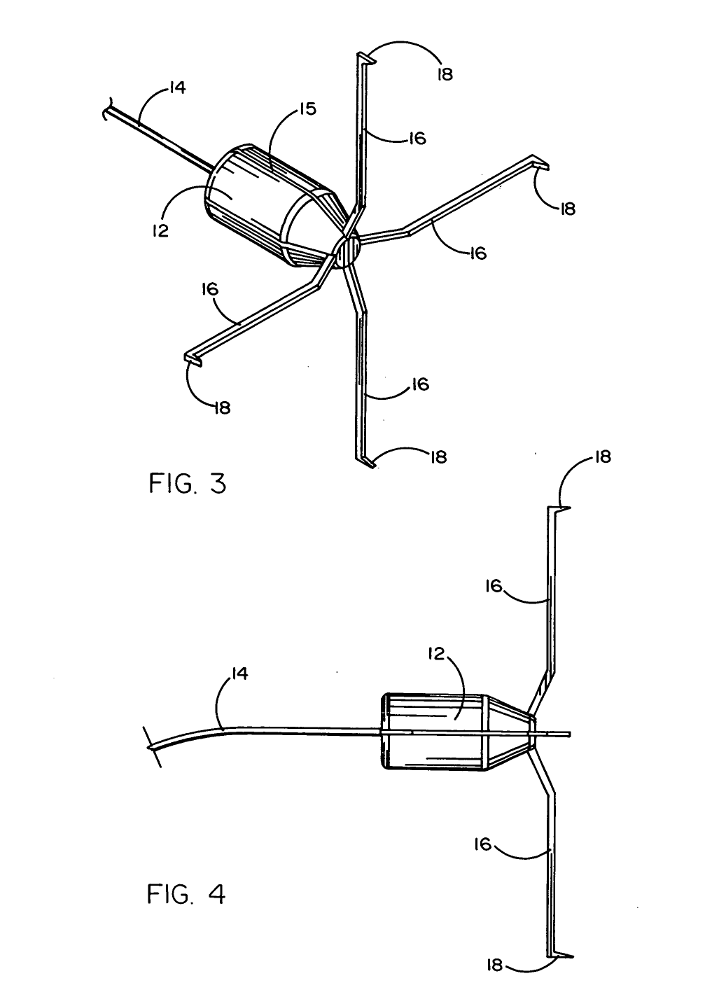

Referring first to FIGS. 1-4 and FIGS. 1 and 2 in particular, it will be seen that a first embodiment 10 comprises a projectile 12 attached to a tether cable 14 having two wires connected to opposite polarities. It will be understood that the tether cables shown herein each have a pair of well insulated electrical wires connected to a source of high voltage. Four contact arms 16 extend longitudinally along the surface of the projectile 12 in corresponding grooves 15 and extend rearwardly beyond the projectile. They are each rotatably secured at a nose portion 20 at respective fulcrums 22. The rearward ends of the arms 16 each terminate in a fleshette or barb 18. As shown best in FIGS. 3 and 4, after impact with a target, the arms 16 swing forward around their respective fulcrums 22 until the barbs 18 face forward (to contact the target) and thereby effectively “grasp” the target at multiple spaced locations.

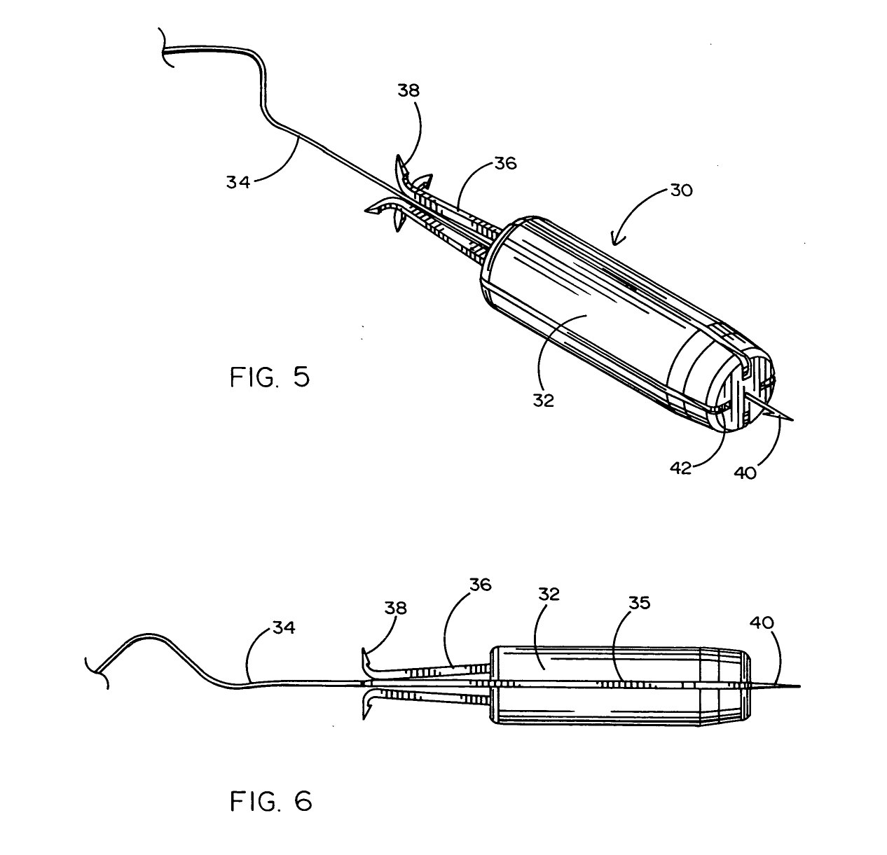

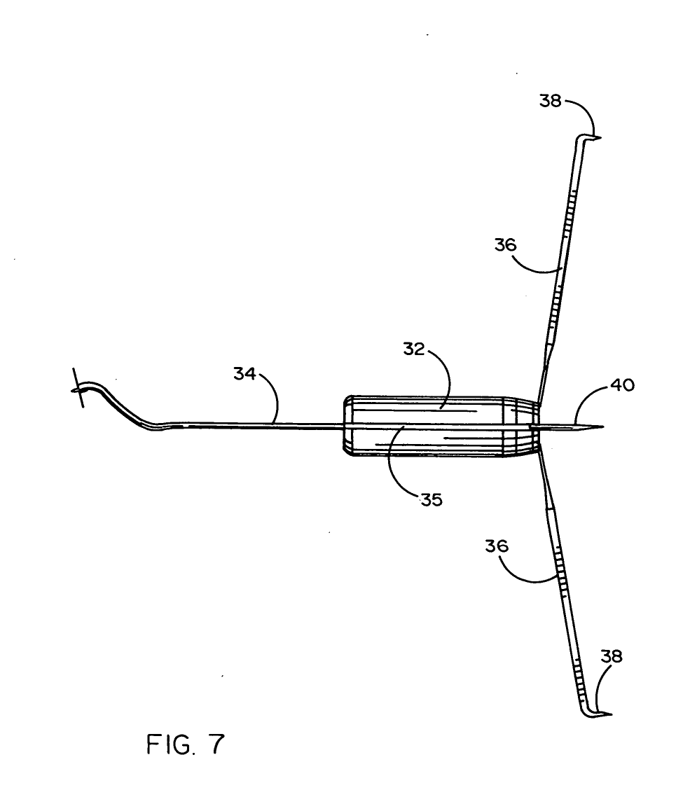

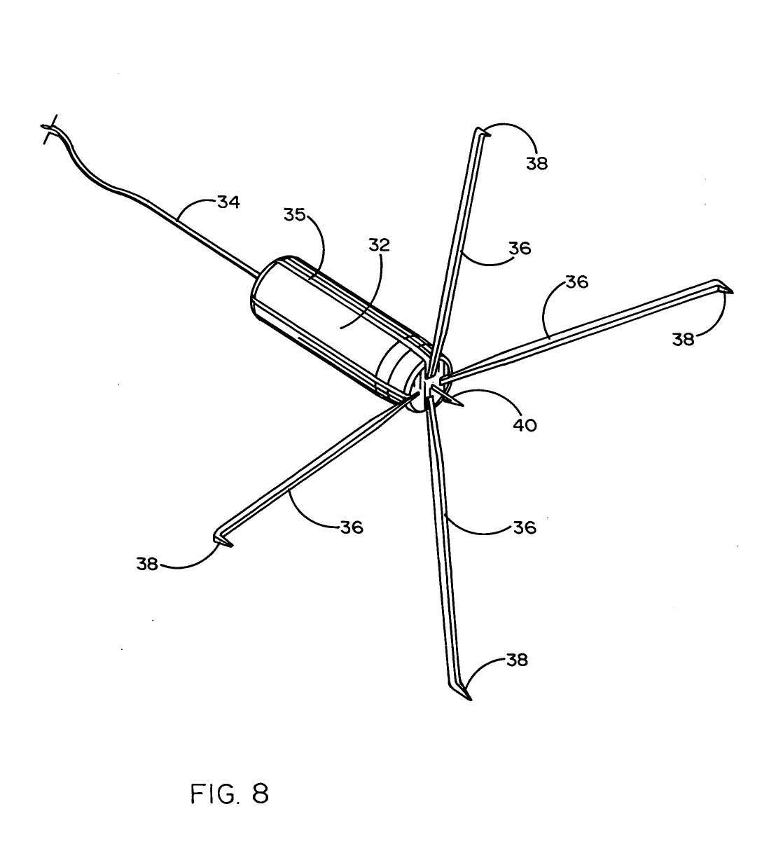

A second embodiment 30 shown in FIGS. 5-8 is similar to the first embodiment but with three differences. A projectile 32 is longer and thinner and has its own barb-shaped contact 40 extending forward. Four contact arms 36 extend toward the tether cable 34 within the profile of the projectile which has grooves 35 to hold the arms during flight. Fleshettes or barbs 38 are also within the outer profile of the projectile. On impact with the target (not shown) the arms 36 swing forward around fulcrums 42 allowing barbs 38 to become embedded in the target surface at four symmetrically spaced locations that are in about the same plane having the end of barb 40.

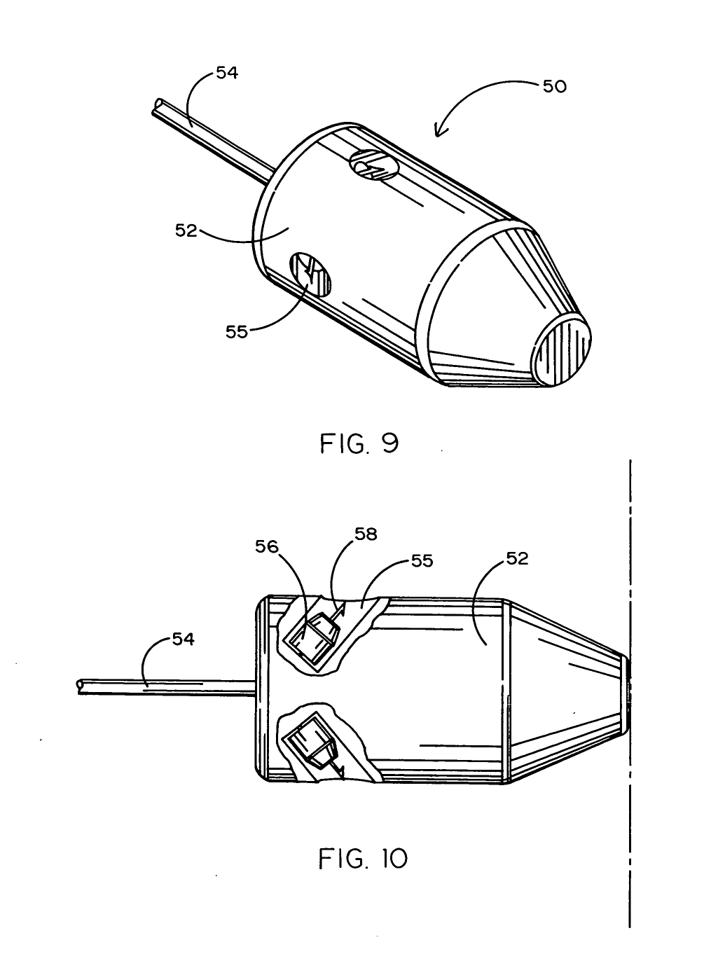

A third embodiment 50 shown in FIGS. 9 and 10 has a projectile 52 attached to a tether cable 54. Four angled recesses 55 contain respective contact bodies 56 each having a fleshette or barb 58. The bodies 56 rest in their respective recesses 55 during flight and then fly out at an angle upon impact of the projectile with a target. The bodies are attached to the projectile by respective wires so that each can make electrical contact with the surface of the target.

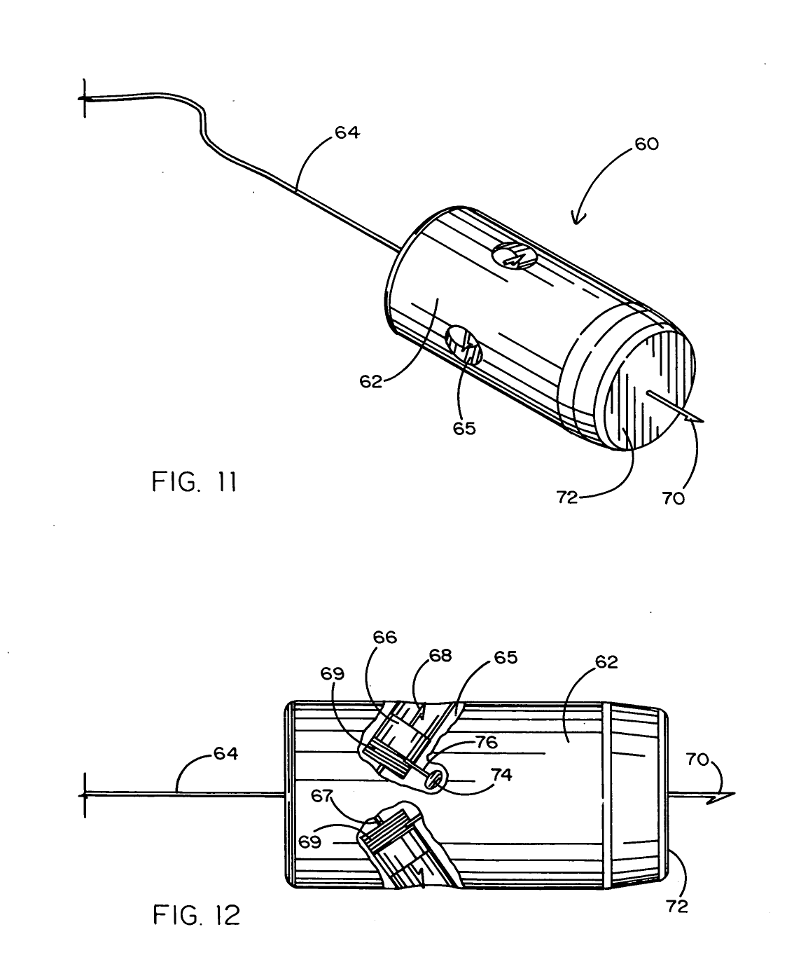

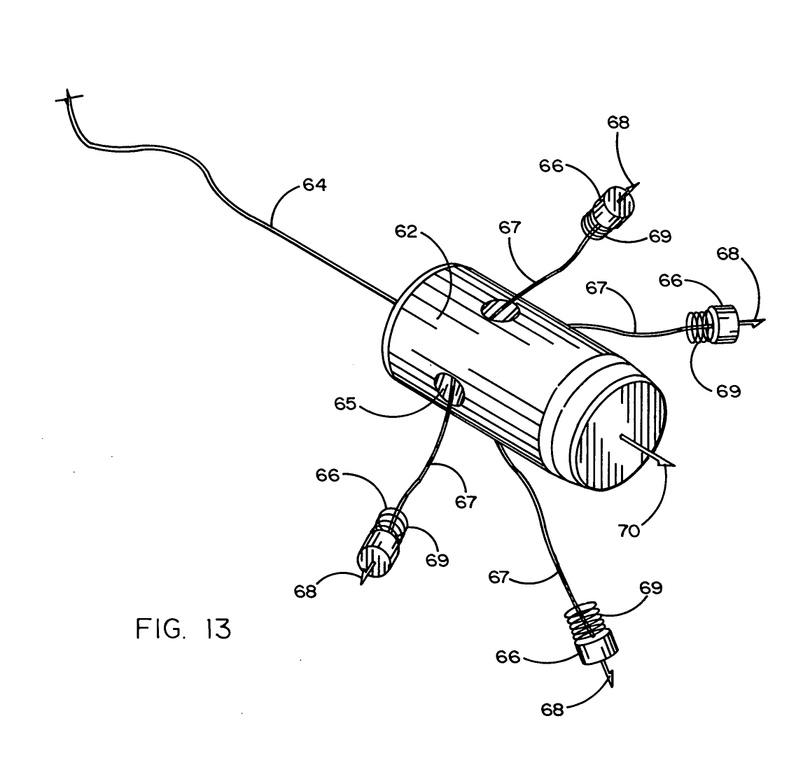

The fourth embodiment 60 of FIGS. 11-13 differs in that a projectile 62 attached to a tether cable 64 is trimmer and has its own extending barbed contact 70 at the impact surface 72. Four angled recesses 65 contain contact bodies 66 in flight. Each contact body is attached to a wired 67 and has a fleshette or barb shaped contact 68. A helical spring 69 is compressed behind each body 66 within recess 65. Upon contact of the projectile 62 with a target, the springs are released to propel the contact bodies at an angle toward the target surface to engage respective fleshettes with the target as shown in FIG. 13. A latch mechanism responsive to projectile impact for releasing springs 69 and propelling bodies 66, is well known in the art and need not be disclosed herein in detail. As shown in FIG. 12, a mass 74 is attached to a latch 76 which secures spring 69 in a compressed state during flight. When surface 72 hits a target, mass 74 is propelled forward and pulls latch 76 away from spring 69 thereby allowing the spring to suddenly expand and propel contact body out of recess 65.

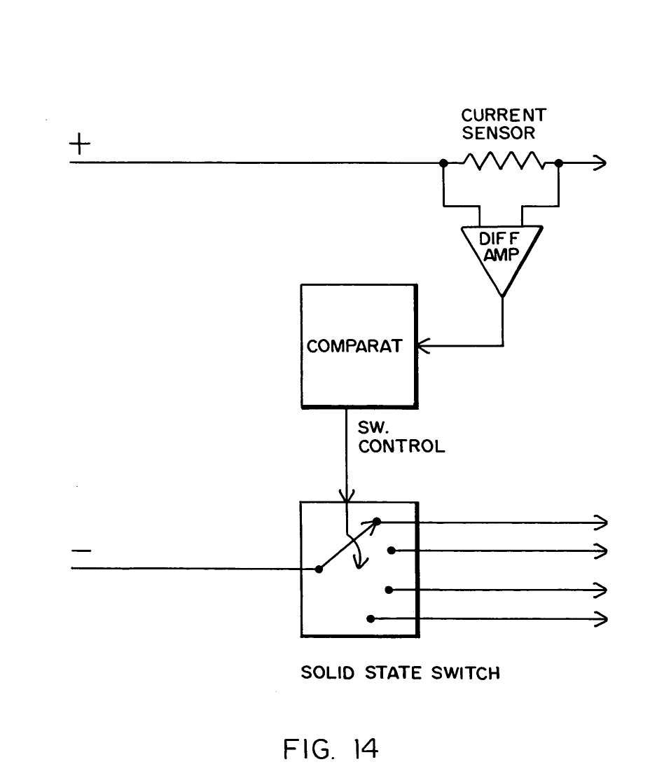

FIG. 14 illustrates an electrical device designed to be in the projectile for selecting one of four contacts to be used as a return for the electrical circuit formed with the target for the second and fourth embodiments of the invention where the projectile has its own contact. The best selection will be one which results in the highest current into the target. A current sensing resistor in series with the projectile contact provides a voltage input to a differential amplifier, the output of which is input to a comparator. The comparator controls a four position solid state switch shown symbolically in FIG. 14 and selects that switch position corresponding to the one contact of four which results in the highest voltage drop across the current sensing resistor. This entire process using solid state circuitry can take no more than several milliseconds so that it does not interfere with immobilization operation after impact with the projectile. Moreover, it can be designed to operate on a very small lithium battery (i.e., 3 Volt watch battery) which will not add much weight to the projectile. A comparable circuit can be used to select the best two of four contacts for the first and third embodiments where the projectile does not have its own contact.

Having thus disclosed several alternatives embodiments of the improved weapon, it will now be apparent that various other configuration are possible. By way of example, it is also contemplated to spring load each contact arm of the embodiments of FIGS. 1-8 so that the arm movement will be more forceful than that which results from freely swinging the arm into contact position at impact with the target. Accordingly, the scope of protection provided herein is not to be limited by the specification but only by the appended claims and their equivalents. Moreover, any claim term defined in the description should be given the broadest definition commonly ascribed to that term, as the specification is primarily for the purpose of providing illustrative examples of the preferred embodiments and is not intended to be limiting of the rights of exclusion afforded hereby.

I claim:

1. A dual wire-tethered unitary projectile for use in an electrical discharge immobilization weapon wherein the projectile is fired using a propulsive force toward a remote target for imparting an electrical current through the target after impact; the projectile comprising:
a dual wire-tethered projectile body;
a plurality of contact arms rotatably secured to the projectile body and having a first stable position during projectile flight toward the target and a second stable position after impact of the projectile with the target;
said first stable position being aerodynamic to promote an accurate trajectory of said body;
said second stable position forming a pattern of spaced contact arm locations for increasing the probability of electrical contact with said target.

2. The projectile recited in claim 1 wherein said contact arms are configured for movement from said first stable position to said second stable position by a sudden deceleration of said projectile body upon its impact with a target.

3. The projectile recited in claim 1 wherein each of said contact arms terminates in a barb for promoting adherence of each contact arm to the target in said second stable position.

4. The projectile recited in claim 1 wherein said projectile body comprises a plurality of elongated grooves for receiving said contact arms in their first stable position.

5. The projectile recited in claim 1 wherein said projectile body comprises a contact barb affixed to the body and extending toward the target.

6. The projectile recited in claim 1 said body having an outer profile defined by the dimensions of said body and wherein when said contact arms are in said first stable position, no portion of said arms lies outside said body profile.

7. The projectile recited in claim 1 further comprising an electronic circuit contained within said body and being connected to each of said contact arms for determining which of said contact arms provide an effective immobilization current through said target.

8. The projectile recited in claim 7 wherein said electronic circuit also comprises at least one switch for selecting at least one contact arm to transmit said immobilization current through said target.

9. The projectile recited in claim 1 wherein said plurality of contact arms comprises at least two such contact arms.

10. A dual wire-tethered unitary projectile for use in an electrical discharge immobilization weapon wherein the projectile is fired using a propulsive force toward a remote target for imparting an electrical current through the target after impact; the projectile comprising:
a dual wire-tethered projectile body;
a plurality of contact members secured to the projectile body and having a first stable position during projectile flight toward the target and a second stable position after impact of the projectile with the target;
said first stable position being aerodynamic to promote an accurate trajectory of said body;
said second stable position forming a pattern of spaced contact member locations for increasing the probability of electrical contact with said target.

11. The projectile recited in claim 10 wherein said contact members are configured for movement from said first stable position to said second stable position by a sudden deceleration of said projectile body upon its impact with a target.

12. The projectile recited in claim 10 wherein each of said contact members terminates in a barb for promoting adherence of each contact member to the target in said second stable position.

13. The projectile recited in claim 10 wherein said projectile body comprises a plurality of angled recesses for receiving said contact members in their first stable position.

14. The projectile recited in claim 10 wherein said projectile body comprises a contact barb affixed to the body and extending toward the target.

15. The projectile recited in claim 10 further comprising an electronic circuit contained within said body and being connected to each of said contact members for determining which of said contact members provide an effective immobilization current through said target.

16. The projectile recited in claim 15 wherein said electronic circuit also comprises at least one switch for selecting at least one contact member to transmit said immobilization current through said target.

17. The projectile recited in claim 10 wherein said plurality of contact members comprises at least two such contact members.

18. The projectile recited in claim 10 wherein each of said contact members is spring loaded.

19. A dual wire-tethered unitary projectile for use in an electrical discharge immobilization weapon wherein the projectile is fired using a propulsive force toward a remote target for imparting an electrical current through the target after impact; the projectile comprising:
a dual wire-tethered projectile body;
at least three symmetrically spaced contact members secured to the projectile body and having a first stable position during projectile flight toward the target and a second stable position after impact of the projectile with the target;
said first stable position being aerodynamic to promote an accurate trajectory of said body;
said second stable position forming a pattern of spaced contact member locations for increasing the probability of electrical contact with said target.

20. The projectile recited in claim 19 wherein said projectile body comprises an additional contact member affixed to the body and extending toward the target.

21. The projectile recited in claim 19 wherein said contact members are configured for movement from said first stable position to said second stable position by a sudden deceleration of said projectile body upon its impact with a target.

22. The projectile recited in claim 19 wherein each of said contact members terminates in a barb for promoting adherence of each contact member to the target in said second stable position.

23. The projectile recited in claim 19 further comprising an electronic circuit contained within said body and being connected to each of said contact members for determining which of said contact members provide an effective immobilization current through said target.

24. The projectile recited in claim 23 wherein said electronic circuit also comprises at least one switch for selecting at least one contact member to transmit said immobilization current through said target.
